(19) United States
(12) Patent Application Publication
(10) Pub. No.: US 2010/0126060 A1
(43) Pub. Date: May 27, 2010

(54) BIODIESEL PRODUCTION WITH REDUCED WATER EMISSIONS

(75) Inventors: Thomas A. Maliszewski, Charleston, WV (US); Donald L. Bunning, South Charleston, WV (US); David J. Schreck, Lake City, MN (US); Louis A. Kapicak, Cross Lanes, WV (US); Norman L. Balmer, Ridgefield, CT (US)

Correspondence Address: PAULEY PETERSEN & ERICKSON, 2800 WEST HIGGINS ROAD, SUITE 365, HOFFMAN ESTATES, IL, 60169, US

(73) Assignee: BEST ENERGIES, INC., Madison, WI (US)

(21) Appl. No.: 12/523,184

(22) PCT Filed: Jan. 23, 2008
(86) PCT No.: PCT/US2008/051792

§ 371 Date: Jan. 21, 2010

Related U.S. Application Data
(60) Provisional application No. 60/897,128, filed on Jan. 24, 2007.

(51) Int. Cl. C10L 1/19; B01J 8/00

(52) U.S. Cl. 44/388; 422/243

(57) ABSTRACT

Waste water emissions from a biodiesel production facility are substantially reduced by recovering water from a spent water stream used in a water washing step in the refining of crude biodiesel which water washing removes glycerin. The water is recovered from the spent water stream is concentrated to provide an aqueous fraction which can be recycled for the water washing. The concentration also provides a glycerin-containing fraction containing that can be blended with crude glycerin by-product generated by transesterification of glycerides to make the biodiesel.

### CROSS-REFERENCE TO RELATED APPLICATIONS

This Application claims priority to U.S. Provisional Application No. 60/897,128, filed 24 Jan. 2007, the entirety of which application is incorporated herein by reference.

### FIELD OF THE INVENTION

This invention pertains to processes for the synthesis of biodiesel from fats and oils by base catalyzed transesterification with lower alkanol, and particularly to such processes characterized by low water emissions.

### BACKGROUND TO THE INVENTION

Biodiesel is being used as an alternative or supplement to petroleum-derived diesel fuel. Biodiesel can be made from various bio-generated oils and fats from vegetable and animal sources.

One process involves the transesterification of triglycerides in the oils or fats with a lower alkanol in the presence of a catalyst, acidic or basic, to produce alkyl ester useful as biodiesel and a glycerin co-product. In this process, the alkyl ester and glycerin are separated, usually by a phase separation, and the lighter phase containing crude biodiesel is refined. Typically refining operations include the removal of residual alkanol, glycerin and other impurities present in the crude biodiesel. One of the refining unit operations conventionally used is a water washing to remove salts, lower alkanol and residual glycerin.

The spent water from this washing, which is contaminated with lower alkanol, residual glycerin and other organic impurities, is usually sent to sewer. The oxygen demand for the degradation of the organics contained in the water is not insignificant. The biochemical oxygen demand may be in excess of 0.01 kilograms of oxygen per liter of biodiesel produced. This biochemical oxygen demand can require a biodiesel production facility to install a waste water treatment facility or otherwise procure waste water disposal services.

Accordingly, biodiesel production processes are sought that generate a minimum of waste water from water washing of the crude biodiesel.

### SUMMARY OF THE INVENTION

By this invention, processes for making biodiesel are provided that have substantially reduced waste water emissions. In accordance with the processes of this invention, water used for the washing of crude biodiesel to remove lower alkanol and glycerin (spent water) is concentrated, e.g., by membrane separation or fractionation by distillation, to provide a glycerin-containing fraction that contains at least 30 mass percent glycerin, and an aqueous fraction having a reduced concentration of glycerin as compared to the spent water. The aqueous phase can be discharged, or preferably, is recycled as part of the water for washing the crude biodiesel. By concentrating the spent water to provide a glycerin-containing fraction, the glycerin-containing fraction is suitable for admixing with the heavier, glycerin-containing layer from the phase separation of the transesterification reaction product. The combined glycerin-containing fraction and heavier, glycerin-containing layer from the transesterification reaction product phase separation, can be processed or otherwise disposed of in the same manner as a conventional heavier, glycerin-containing layer. Not only is the glycerin-containing fraction from the concentration of a composition similar to that of the glycerin-containing layer from the product phase separation, but also the concentration renders the volume of that fraction to be very minor, often less than about 5, and preferably less than about 3, mass percent of the glycerin-containing layer from the product phase separation.

In its broad aspects, the processes of this invention comprise washing a crude biodiesel stream containing alkyl esters of fatty acids (“alkyl esters”), lower alkanol, and glycerin and often also soaps of fatty acids (“soaps”) with water for a time sufficient to remove at least a portion of the glycerin and soaps, if present, therein to provide an alkyl ester stream of increased purity and a spent water stream; concentrating the spent water stream to provide a aqueous fraction comprising water, said fraction preferably containing less than about 5 mass percent of the total glycerin and soaps, if present, in the spent water stream, and to provide a glycerin-containing fraction comprising glycerin and soaps, if present; and recycling at least a portion of the aqueous fraction as water for washing crude biodiesel. The preferred lower alkanols are methanol, ethanol and isopropanol with methanol being the most preferred.

The concentration provides a glycerin-containing fraction that contains less than about 90, preferably less than about 70, mass percent water. The concentration of glycerin in the glycerin-containing fraction is often in the range of at least about 10, say, about 30 to 70 or 80, mass percent. As the impurities removed from the crude biodiesel are in a relatively small amount, often less than about 2, and sometimes less than about 1, mass percent of the crude biodiesel stream, the absolute amount of water in the glycerin-containing fraction on a relative basis, is minor. Accordingly, the fraction is suitable for combination with other glycerin-containing streams associated with a biodiesel production facility.

The aqueous fraction contains little, if any, i.e., preferably less than about 5 mass percent, and preferably less than about 2 mass percent, of the total glycerin and soaps, if present, in the spent water stream. Often the concentration of total glycerin and soaps in the lower boiling fraction is less than about 0.5, preferably less than about 0.1, mass percent. Advantageously, since significant amounts of water can be acceptable in the higher boiling fraction, the distillation technique can be simple and require minimal heat duty. Due to the significant difference in boiling points between glycerin and water, adequate separation can often be achieved by evaporation. If desired, however, a vapor liquid separation using packing or trays can be used, with or without reflux. Where packing or trays are used, the distilling is a stripping.

Typically the lower alkanol, especially methanol, will be contained in both the lower boiling fraction and the higher boiling fraction from the distillation of the spent water stream.

Although the aqueous fraction contains less organic than the spent water stream from the concentration and thus may be sent to sewer with less biochemical oxygen demand, it is preferred that at least a portion, most preferably all, of the aqueous fraction is recycled as part of the water for washing the crude biodiesel. Even though the aqueous fraction may contain some glycerin and lower alkanol, the efficacy of aqueous fraction for removal of glycerin from the crude biodiesel is not significantly hindered due to the much higher solubility of these components in water as compared to alkyl esters in the biodiesel being refined. Hence, for a retrofit, the processes of this invention do not unduly adversely affect the capacity of existing equipment to achieve the water washing yet still provide for the environmental benefits of this invention.

In preferred aspects, the processes also pertain to the base catalyzed transesterification of glycerides with lower alkanol. These processes comprise:
a. contacting a glyceride-containing feed and lower alkanol under transesterification conditions comprising the presence of a transesterification catalyst, wherein the molar ratio of lower alkanol to glyceride is at least about 3:1 to provide a crude biodiesel containing alkyl esters of fatty acids, glycerin, and lower alkanol, said contacting being for a time sufficient to convert at least about 90 mass percent of the glycerides in the glyceride-containing feed;
b. separating by phase separation said crude biodiesel to provide a heavier glycerin-containing layer and a lighter alkyl ester-containing layer, wherein a portion of the glycerin is contained in each of the heavier and lighter layer;
c. subjecting the lighter layer to vapor fractionation conditions to provide a lower boiling fraction containing lower alkanol and a higher boiling fraction containing alkyl ester and glycerin;
d. water washing the higher boiling fraction containing alkyl ester to provide a biodiesel of increased purity and a spent water stream,
   the improvement comprising concentrating the spent water stream to provide an aqueous fraction and a glycerin-containing fraction; recycling at least a portion of the aqueous fraction as part of the water for the washing of step (d); and combining at least a portion of the glycerin-containing fraction with at least a portion of the heavier glycerin-containing layer of step (b) to provide a combined glycerin stream.

The glycerin-containing fraction from concentrating the spent water stream is similar in composition to the heavier layer from the phase separation of step (b) and thus can be combined, in whole or part with at least a portion of the heavier layer containing glycerin. This combined stream may be refined, burned or otherwise handled as could the heavier layer containing glycerin. Moreover, the volume of the higher boiling fraction is relatively small in comparison to the heavier layer containing glycerin obtained from step (b), e.g., less than about 5, an sometimes less than about 3, mass percent of the heavier layer. Accordingly, the processes of this invention can readily be retrofitted into existing biodiesel production facilities since existing equipment to handle the heavy layer containing glycerin is often sufficiently robust to accommodate such a small increase in volume.

In one preferred aspect, step (a) of the processes is a base-catalyzed transesterification of glycerides. With base catalyzed transesterification, the formation of soaps can occur. Preferably, the pH of the higher boiling fraction to be washed in step (d) is adjusted to less than about 5, most preferably less than about 4, and often between about 0.1 and 4. At these acidities, soaps present can be converted to free fatty acids, thus facilitating the water washing. See, for instance, copending patent application Ser. No. 60/845,718 filed on Sep. 19, 2006, hereby incorporated by reference in its entirety.

Often the transesterification comprises at least two sequential stages, each of which is fed lower alkanol, and between stages, glycerin is separated by phase separation. Step (b) may thus be performed by phase separation between stages or by phase separation between stages and after the final stage. Additional lower alkanol and base catalyst may be added, if desired, to the lighter layer passing to a subsequent reaction zone. Not only does this sequential process facilitate reaching a high conversion of glyceride, but also, the intermediate separation removes a portion of the water introduced into the reaction system with the glyceride-containing feed, water that may be formed in making the catalyst if an alkali metal hydroxide is used, and made in the prior reaction zone, e.g., by the reaction of a free fatty acid with base to form a soap. In one embodiment, at least about 50 mass percent of the glyceride fed to a preceding reactor is reacted in the preceding reactor, a glycerin-containing phase is separated from the transesterification product of the first reaction zone and a glyceride and alkyl ester-containing layer is fed to a subsequent reaction zone for substantial completion of the transesterification. The transesterification product from the subsequent reaction zone may be subjected to another phase separation to recover glycerin. In another embodiment, the preceding reaction zone effects at least about 90, preferably between about 92 to 98, percent of the conversion of the glyceride; a phase separation of a glycerin-containing layer is effected and substantial completion of the conversion of the glyceride is effected in the subsequent reaction zone and the transalkylation product from the subsequent transalkylation zone is subjected to step (c) without an intervening phase separation unit operation. Where more than one transalkylation reaction zone is used, the ratio of alkanol to glyceride may be the same or different in each zone.

### BRIEF DESCRIPTION OF THE DRAWINGS

FIG. 1 is a schematic depiction of a biodiesel facility using the processes of this invention.

FIG. 2 is a schematic depiction of a portion of a biodiesel production facility related to the washing of crude biodiesel.

FIG. 3 is a schematic depiction of a two stage washing apparatus that can be used in the practice of the processes of this invention.

### DETAILED DISCUSSION

The following discussion is in reference to the facility depicted in the Figures. The Figures are not intended to be in limitation of this invention.

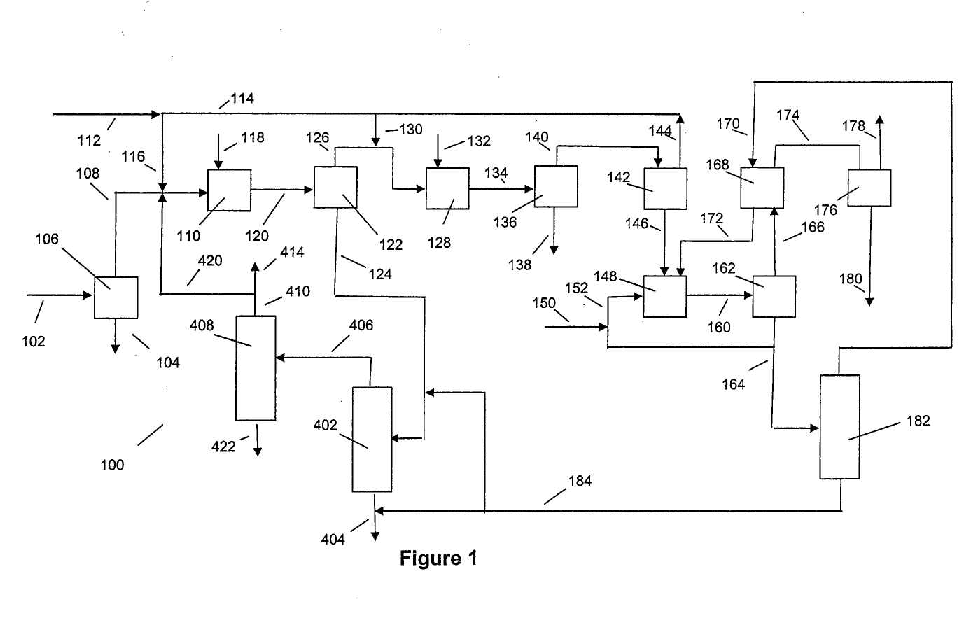

With respect to FIG. 1, biodiesel manufacturing facility 100 uses a suitable raw material feed provided via line 102. The feed may be one or more suitable oils or fats derived from bio sources, especially vegetable oils and animal fats. Examples of fats and oils are rape seed oil, soybean oil, cotton seed oil, safflower seed oil, castor bean oil, olive oil, coconut oil, palm oil, corn oil, canola oil, fats and oils from animals, including from rendering plants and fish oils. The oils and fats may contain free fatty acids falling within a broad range. Generally, the free fatty acid in the raw material feed is less than about 60, and unless pretreatment occurs to remove free fatty acids, preferably less than about 10, mass percent (dry basis). The balance of the fats and oils is largely fatty acid triglycerides. The unsaturation of the free fatty acids and triglycerides may also vary over a wide range. Typically, some degree of unsaturation is preferred to reduce the propensity of the biodiesel to gel at cold temperatures.

As shown, the raw material feed in line 102 is passed to pretreatment unit 106 which may effect one or more unit operations to enhance the feed as a transesterification feedstock such as drying, free fatty acid removal, filtration to remove particulates, and the like. Line 104 shows a discharge of rejected material from such unit operations. Reference is made to co-pending patent application Ser. No. 60/845,718 filed on Sep. 19, 2006, hereby incorporated by reference in its entirety, for processes for removing fatty acids.

A glyceride-containing feed is passed from unit operations 106 via line 108 to reactor 110 for transesterification. The transesterification is a catalyzed reaction with a lower alkanol, preferably methanol, ethanol or isopropanol. Higher alkanols can be used. Methanol is the most preferred alkanol not only due to its availability but also because of its ease of recovery by vapor fractionation. For purposes of the following discussion, methanol will be the alkanol. The catalysis may be acid or base catalysis. Acid catalysts include heterogeneous and homogeneous acids including, but not limited to, sulfuric acid, hydrochloric acid, sulfonic acid, toluene sulfonic acid, phosphoric acid, perchloric acid, and nitric acid as well as acidic ion exchange resins. For representative processes, see U.S. Pat. No. 6,822,105; U.S. Patent Application Publication No. 2005/0204612; and Canakci, et al., Transactions of ASAE, 42, 5, pp. 1203-10 (1999), herein incorporated in their entireties by reference. Base catalysis will be described in further detail below.

As shown, methanol is supplied via line 112 to methanol header 114. Line 116 supplies methanol to reactor 110. Although line 116 is depicted as introducing methanol into line 108, it is also contemplated that methanol can be added directly to reactor 110. Generally methanol is supplied only in a slight excess above that required to achieve the sought degree of transesterification in reactor 110. More methanol can be supplied but it may be lost from the facility. Preferably, the amount of methanol is from about 101 to 500, more preferably, from about 105 to 200, mass percent of that required for the sought degree of transesterification in reactor 110. In the facility depicted, two reactors are used. One reactor may be used, but since the reaction is equilibrium limited, most often at least two reactors are used. Often, where more than one reactor is used, at least about 60, preferably between about 70 and 96, percent of the glycerides in the feed are reacted in the first reactor.

The base catalyst is shown as being introduced via line 118 to reactor 110. Preferably, the amount of catalyst is from about 101 to 200, more preferably, from about 101 to 150, mass percent of that required for the sought degree of transesterification in reactor 110. The amount of catalyst used will reflect the amount of base that will react with free fatty acids to form soaps in the transesterification. Free fatty acids may be present in the feed to the reactor as well as be formed as a side product during the transesterification reaction. The base catalyst may be an alkali or alkaline earth metal hydroxide or alkali or alkaline earth metal alkoxide, especially an alkoxide corresponding to the lower alkanol reactant. The preferred alkali metals are sodium and potassium. When the base is added as a hydroxide, it may react with the lower alkanol to form an alkoxide with the generation of water. The exact form of the catalyst is not critical to the understanding and practice of this invention.

The transesterification in reactor 110 is often at a temperature between about 30° C. and 220° C., preferably between about 30° C. and 80° C. The pressure is typically in the range of between about 90 to 500 kPa (absolute) although higher and lower pressures can be used. The reactor is typically batch, semi-batch, plug flow or continuous flow tank with some agitation or mixing, e.g., mechanically stirred, ultrasonic, static mixer, e.g., a packed bed, baffles, orifices, venturi nozzles, tortuous flow path, or other impingement structure. The residence time will depend upon the desired degree of conversion, the ratio of methanol to glyceride, reaction temperature, the degree of agitation and the like, and is often in the range of about 0.1 to 20, say, 0.5 to 10, hours.

The partially transesterified effluent for reactor 110 is passed via line 120 to phase separator 122. Phase separator 122 may be of any suitable design and provides a glycerin-containing bottoms stream passed via line 124. The material in line 124 can be subjected to suitable unit operations to recover components thereof. This stream also contains any soaps made in reactor 110 and a portion of the catalyst. The lighter phase contains alkyl esters and unreacted glycerides and is passed via line 126 to second transesterification reactor 128.

Reactor 128 may be of any suitable design and may be similar to or different than reactor 110. As shown, additional methanol is provided via line 130 from methanol header 114 and additional catalyst is provided via line 132. Preferably the transesterification conditions in reactor 128 are sufficient to react at least about 90, more preferably at least about 95, and sometimes at least about 97 to 99.9, mass percent of the glycerides in the feed to reactor 110. The transesterification in reactor 128 is typically operated under conditions within the parameters set forth for reactor 110 although the conditions may be the same or different. The residence time will depend upon the desired degree of conversion. Typically, it is desired that the conversion be at least about 98, preferably at least about 99, percent complete bases upon the conversion of the glycerides in the feed.

The effluent from reactor 128 is passed via line 134 to phase separator 136 which may be of any suitable design and may be the same as or different from the design of separator 122. A heavier, glycerine-containing phase is withdrawn via line 138. This stream contains some catalyst and methanol. A lighter phase containing crude biodiesel is withdrawn from separator 136 via line 140. The lighter phase also contains catalyst and methanol.

The crude is then passed without catalyst neutralization to methanol separator 142. Methanol separator 142 effects a fast, vapor fractionation of the lower alkanol from the crude biodiesel and may be of any convenient design including a stripper, wiped film evaporator, falling film evaporator, and the like. Where subatmospheric pressure is used, it is preferred to use a liquid ring vacuum pump. Water can be used as the sealing fluid or at least one of glyceride-containing feed, alkyl ester, free fatty acid and glycerin can be used as disclosed in copending patent application (Atty. Docket GEIN 106), filed on even date herewith and incorporated in its entirety herein.

As stated above, a falling film evaporator is the preferred apparatus for effecting the vapor fractionation. The tubes of the falling film evaporator may be circular in cross section or any other convenient cross-sectional shape, and the tubes may have a constant cross-sectional configuration over their length or may be tapered or otherwise change in cross-sectional configuration.

Often the vapor fractionation recovers at least about 70, preferably at least about 90, mass percent of the lower alkanol contained in the crude biodiesel. Any residual alkanol is substantially removed in any subsequent water washing of the crude biodiesel. Advantageously, the amount of alkanol contained in the spent water from the washing may be at a sufficiently low concentration that the water can be disposed without further treatment. However, from a process efficiency standpoint, methanol can be recovered from the spent wash water for recycle to the transesterification reactors.

The lower boiling fraction containing the lower alkanol will contain a portion of any water contained in the crude biodiesel. Since the transesterification is conducted with little water being present, and a portion of the water is removed with the glycerin, the concentration of water in this fraction can be sufficiently low that it can be recycled to the transesterification reactors. This lower boiling fraction often contains less than about 0.1, and more preferably less than about 0.05, mass percent water. The methanol-containing fraction is removed from separator 142 via line 144 and may be exhausted from the facility as a waste stream, e.g., for burning or other suitable disposal, or can be added to the methanol header 114.

The methanol separation preferably lowers the lower alkanol content of the bottoms stream to less than about 10, more preferably less than about 2, milligrams of lower alkanol per kilogram of alkyl ester in the bottoms stream. The bottoms stream from methanol separator 142 is contacted with an aqueous acid solution to neutralize the catalyst.

As shown, the bottoms stream is subjected to a strong acid treatment to recover free fatty acids. The use of this technique is optional and is disclosed in copending patent application Ser. No. 60/845,718 filed on Sep. 19, 2006, hereby incorporated by reference in its entirety. Often, if only base catalyst neutralization is sought, a much weaker and smaller volume acid solution can be used.

The bottoms stream is passed via line 146 to mixer 148. Into mixer 148 is passed a strong acid aqueous solution via line 152. Mixer 148 may be an in-line mixer or a separate vessel. Mixer 148 should provide sufficient mixing and residence time that essentially all of the soaps are converted to free fatty acids. Often the temperature during the mixing is in the range of about 80° C. to 220° C., and for a residence time of between about 0.01 to 4, preferably 0.02 and 1, hours.

In accordance with the processes of this invention, the strong acid aqueous solution introduced via line 152 has a pH sufficient to convert the soaps to free fatty acids. Often the pH is less than about 5, sometimes less than about 4, and more preferably less than about 3, say, between about 0.1 and 2.5. The acid may be any suitable acid to achieve the sought pH such as hydrochloric acid, sulfuric acid, sulfonic acid, phosphoric acid, perchloric acid and nitric acid. Sulfuric acid is preferred due to cost and availability. The amount of strong acid aqueous solution provided is typically in a substantial excess of that required to convert the soaps to free fatty acid and to neutralize any remaining catalyst. The excess of acid is often at least about 5, preferably at least about 10, say between about 10 and 1000 times that required. Consequently the effluent from mixer 148 is at a pH of up to about 4, preferably between about 0.1 and 3.

The effluent from mixer 148 is passed via line 160 to phase separator 162. Phase separator 162 may be of any suitable design. A lower aqueous phase is withdrawn via line 164 for distillation. If desired, a portion of this aqueous phase can be recycled via line 152 to mixer 148. Make-up acid is provided via line 150 to line 152. Alternatively, make-up acid can be added to line 172, described below and no recycle 152 need be employed.

The lighter phase which contains crude biodiesel and free fatty acid is withdrawn via line 166 and is passed to water wash column 168. Fresh water enters column 168 via line 170 and serves to remove residual methanol and salts from the crude biodiesel. Normally the column is operated at a temperature between about 20° C. and 80° C., preferably between about 35° C. and 75° C. In a preferred embodiment, the spent water from wash column 168 is passed via line 172 to mixer 148 or combined with the aqueous solution in line 152.

Water wash column 168 may be of any suitable design. Typically, the water wash column operates with a recycling water loop, often with the recycle being at least about 20, say between about 50 and 500, mass percent of the crude biodiesel being fed to the column. A purge is taken from the loop via line 172. The purge balances the amount of water (aqueous phase) being provided via line 170. The purge is usually at a rate of between about 1 and 50, say 5 and 20, mass percent per unit time of the recycle rate in the loop.

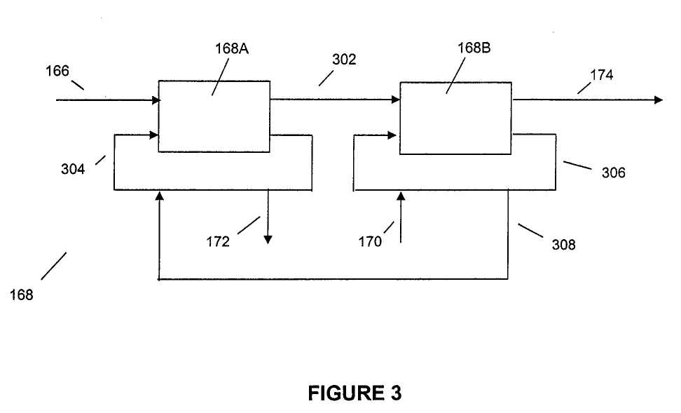

With reference to FIG. 3, a two stage water wash column 168 is depicted having a first stage 168A and a second stage 168B. As shown, crude biodiesel is provided via line 166 to first stage 168A and is cocurrently contacted with water from water loop 304. The washed biodiesel from first stage 168A is passed via line 302 to second stage 168B where it is cocurrently contacted with water from water loop 306. In each stage the water, after contacting the biodiesel stream being processed, is returned to the respective loops. The water being provided via line 170 is directed to loop 306 for the second stage. A portion of the stream in loop 306 is passed via line 308 to loop 304 for the first stage of the water wash column. The purge is taken from loop 304 via line 172.

A washed biodiesel stream is withdrawn from washing column 168 via line 174 and is passed to drier 176 to remove water and residual methanol which exhaust via line 178. Drier 176 may be of any suitable design such as stripper, wiped film evaporator, falling film evaporator, and solid sorbent. Generally the temperature of drying is between about 80° C. and 220° C., say, about 100° C. and 180° C. The dried biodiesel is withdrawn as product via line 180. The biodiesel product contains free fatty acid and preferably has a free fatty acid content of less than about 0.8, and more preferably less than about 0.5, mass percent.

Returning to line 164, the aqueous phase from separator 162 is passed to evaporator 182 which provides a lower boiling fraction and a higher boiling fraction. While an evaporator may be used, it is also possible to use a packed or trayed distillation column with or without reflux. Generally the bottoms temperature of evaporator 182 is less than about 150° C., preferably between about 120° C. and 150° C. The distillation may be at any suitable pressure. A membrane separation system may, alternatively or in combination, be used with evaporator 182 to effect the sought concentration of the spent water.

By way of example, a biodiesel production facility in which spent water stream from the water washing of crude biodiesel is sewered, has a biochemical oxygen demand of 0.020 kilograms of oxygen per liter of biodiesel product for waste waster streams. The same plant, but using the process of this invention, has a biochemical demand of less than 0.0004 kilograms of oxygen per liter of biodiesel product for waste waster streams.

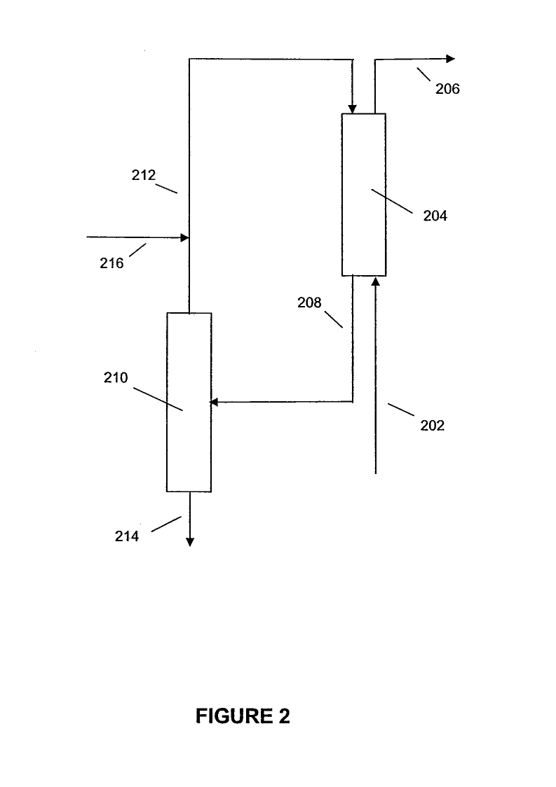

With reference to FIG. 2, crude biodiesel containing glycerin and lower alkanol is supplied by line 202 to washing column 204. A refined biodiesel product is obtained from washing column 204 via line 206. This refined biodiesel product will contain water and is typically dried.

In washing column 204, the crude biodiesel is contacted with an aqueous stream provided by line 212. A spent water stream exits washing column 204 via line 208 and is fed to evaporator 210 which provides a lower boiling fraction which is recycled via line 212 to washing column 204. If needed, make-up water can be provided by line 216. Often, however, ample water is contained in the crude biodiesel such that this make-up is not required. Also, evaporator 210 provides a higher boiling fraction containing glycerin, lower alkanol, and some water, and this fraction is removed via line 214.

As shown, the glycerin-containing layer from line 124 is fractionated to recover glycerin, which can be sold or used as a by-product, and recover methanol, which can be recycled to the reaction system. In further detail, but not in limitation of the broad aspects of the invention, the glycerin-containing layer from line 124 and the higher boiling fraction from line 184 of evaporator 182 are passed to stripping column 402 which provides a methanol and water-containing overhead and a glycerin bottoms stream which generally contains less than about 5 mass percent methanol. The glycerin bottoms stream is discharged via line 404 and the overhead is passed via line 406 to dehydration column 408.

As shown, dehydrating column 408 provides a water-containing bottoms stream for discharge via line 422. A lower boiling stream is passed via line 410. Condensed methanol is passed via line 420 to line 108 for recycle to the reaction system. A gaseous fraction is discharged via line 414.

It is claimed:

1. A process for removing impurities from crude biodiesel stream comprising washing the crude biodiesel stream, which stream contains alkyl esters of fatty acids, lower alkanol, and glycerin, with water for a time sufficient to remove at least a portion of the glycerin therein to provide an alkyl ester stream of increased purity and to provide a spent water stream; and concentrating the spent water stream to provide an aqueous fraction comprising water, said fraction containing less than about 5 mass percent of the total glycerin in the spent water stream, and to provide a glycerin-containing fraction.

2. The process of claim 1 wherein the lower alkanol is at least one of methanol, ethanol and isopropanol.

3. The process of claim 2 wherein the lower alkanol is methanol.

4. The process of claim 1 wherein the glycerin-containing fraction contains at least about 30 mass percent glycerin.

5. The process of claim 1 wherein the concentrating is achieved by a membrane separation.

6. The process of claim 1 wherein the concentrating is achieved by distillation.

7. The process of claim 6 wherein the distilling is effected by stripping.

8. The process of claim 1 wherein the pH of the crude biodiesel stream is less than about 5.

9. The process of claim 1 wherein the concentration of lower alkanol in the crude biodiesel is less than about 10 milligrams per kilogram.

10. In a process for making biodiesel comprising:
a. contacting a glyceride-containing feed and lower alkanol under transesterification conditions, wherein the molar ratio of lower alkanol to glyceride is at least about 3:1 to provide a crude biodiesel containing alkyl esters of fatty acids, glycerin, and lower alkanol, said contacting being for a time sufficient to convert at least about 90 mass percent of the glycerides in the glyceride-containing feed;
b. separating by phase separation said crude biodiesel to provide a heavier glycerin-containing layer and a lighter alkyl ester-containing layer, wherein a portion of the glycerin is contained in each of the heavier and lighter layer;
c. subjecting the lighter layer to vapor fractionation conditions to provide a lower boiling fraction containing lower alkanol and a higher boiling fraction containing alkyl ester and glycerin;
d. water washing the higher boiling fraction containing alkyl ester to provide a biodiesel of increased purity and a spent water stream,
the improvement comprising concentrating the spent water stream to provide an aqueous fraction and a glycerin-containing fraction; and combining at least a portion of the glycerin-containing fraction with at least a portion of the heavier glycerin-containing layer of step (b) to provide a combined glycerin stream.

11. The process of claim 10 wherein the lower alkanol is at least one of methanol, ethanol and isopropanol.

12. The process of claim 11 wherein the lower alkanol is methanol.

13. The process of claim 11 wherein the glycerin-containing fraction contains at least about 30 mass percent glycerin.

14. The process of claim 13 wherein at least a portion of the aqueous fraction is recycled as part of the water for the washing of step (d).

15. The process of claim 14 wherein the lower alkanol concentration of the higher boiling fraction containing alkyl ester is less than about 10 milligrams per kilogram of alkyl ester.

16. The process of claim 15 wherein the higher boiling fraction containing alkyl ester of step (c) is provided at a pH stream is less than about 5 for step (d).

17. The process of claim 16 wherein the concentrating is achieved by a membrane separation.

18. The process of claim 16 wherein the concentrating is achieved by distillation.

19. The process of claim 18 wherein the distilling is effected by stripping.

20. An apparatus for conducting the process of claim 10.
